(19) United States
(12) Patent Application Publication
(10) Pub. No.: US 2014/0344434 A1
(43) Pub. Date: Nov. 20, 2014

(54) INFORMATION PROCESSING APPARATUS, INFORMATION PROCESSING METHOD, AND PROGRAM

(71) Applicant: SONY CORPORATION, Tokyo (JP)

(72) Inventor: ATSUSHI ISHIHARA, Tokyo (JP)

(73) Assignee: SONY CORPORATION, Tokyo (JP)

(21) Appl. No.: 14/266,476

(22) Filed: Apr. 30, 2014

(30) Foreign Application Priority Data
May 16, 2013 (JP) 2013-103669

(51) Int. Cl. H04L 12/24

(52) U.S. Cl. CPC H04L 41/32
USPC 709/223

(57) ABSTRACT

There is provided an information processing apparatus including a receiver configured to receive an answer of a user to a question output from at least one device which has been uniquely identified on a network, and a device recognition part configured to recognize whether the user designates the device by comparing a correct answer to the question with the answer.

### CROSS REFERENCE TO RELATED APPLICATIONS

This application claims the benefit of Japanese Priority Patent Application JP 2013-103669 filed May 16, 2013, the entire contents of which are incorporated herein by reference.

### BACKGROUND

The present disclosure relates to an information processing apparatus, an information processing method, and a program.

The number of devices connected to a network has recently been increased. It is becoming common at home to connect a TV, a recorder, a personal computer (PC), a network attached storage (NAS), and the like are connected to each other through a network such as a local area network (LAN). In the current situation, there have been suggested many techniques for uniformly controlling devices on the network using a device in which an interactive agent program is installed. For example, JP 2001-306199A describes a network equipment controller for uniformly controlling a plurality of devices connected to a network through dialogue with a personified agent. Further, JP H11-311996A also describes a speech device capable of controlling a plurality of network devices.

### SUMMARY

However, with a protocol like universal plug and play (UPnP) used in the techniques as described in JP 2001-306199A and JP H11-311996A, it is possible to obtain information such as a model number of a device, but it is difficult to obtain information like where the device is installed and how the device is recognized by a user. Accordingly, even if an interface is personified, it is necessary to perform the same device-setting operation as before in order to use the interface, and the usability is not sufficient.

In light of the foregoing, it is desirable to provide an information processing apparatus, an information processing method, and a program which are novel and improved, and which can acquire information for recognizing a device on a network through natural exchange with a user.

According to an embodiment of the present disclosure, there is provided an information processing apparatus which includes a receiver configured to receive an answer of a user to a question output from at least one device which has been uniquely identified on a network, and a device recognition part configured to recognize whether the user designates the device by comparing a correct answer to the question with the answer.

According to another embodiment of the present disclosure, there is provided an information processing method which includes receiving an answer of a user to a question output from at least one device which has been uniquely identified on a network, and recognizing whether the user designates the device by comparing a correct answer to the question with the answer.

According to another embodiment of the present disclosure, there is provided a program for causing a computer to achieve a function of receiving an answer of a user to a question output from at least one device which has been uniquely identified on a network, and a function of recognizing whether the user designates the device by comparing a correct answer to the question with the answer.

According to one or more of embodiments of the present disclosure, information for recognizing a device on a network through natural exchange with a user can be acquired.

### BRIEF DESCRIPTION OF THE DRAWINGS

FIG. 1 is a diagram showing a configuration example of a system according to an embodiment of the present disclosure;

FIG. 2 is a block diagram showing a configuration example of an electronic device according to an embodiment of the present disclosure;

FIG. 3 is a block diagram showing a configuration example of a server according to an embodiment of the present disclosure;

FIG. 4 is a block diagram showing a functional configuration example of an agent according to an embodiment of the present disclosure;

FIG. 5 is a diagram showing an example of contents of a question DB according to an embodiment of the present disclosure;

FIG. 6 is a diagram showing an example of contents of a device DB according to an embodiment of the present disclosure;

FIG. 7 is a flowchart showing an example of processing performed by an agent according to an embodiment of the present disclosure;

FIG. 8 is a diagram illustrating a first example of a specific utilization form according to an embodiment of the present disclosure;

FIG. 9 is a diagram illustrating the first example of a specific utilization form according to an embodiment of the present disclosure;

FIG. 10 is a diagram illustrating the first example of a specific utilization form according to an embodiment of the present disclosure;

FIG. 11 is a diagram illustrating the first example of a specific utilization form according to an embodiment of the present disclosure;

FIG. 12 is a diagram illustrating the first example of a specific utilization form according to an embodiment of the present disclosure;

FIG. 13 is a diagram illustrating a second example of a specific utilization form according to an embodiment of the present disclosure;

FIG. 14 is a diagram illustrating a third example of a specific utilization form according to an embodiment of the present disclosure;

FIG. 15 is a diagram illustrating a fourth example of a specific utilization form according to an embodiment of the present disclosure;

FIG. 16 is a diagram illustrating the fourth example of a specific utilization form according to an embodiment of the present disclosure;

FIG. 17 is a diagram illustrating a fifth example of a specific utilization form according to an embodiment of the present disclosure;

FIG. 18 is a diagram illustrating the fifth example of a specific utilization form according to an embodiment of the present disclosure; and

FIG. 19 is a diagram illustrating the fifth example of a specific utilization form according to an embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted. Note that the description will be given in the following order:

1. Configuration example according to one embodiment
1-1. Configuration example of system
1-2. Configuration examples of devices
1-3. Functional configuration example of agent
1-4. Example of processing flow of agent

2. Examples of specific utilization forms
2-1. First example
2-2. Second example
2-3. Third example
2-4. Fourth example
2-5. Fifth example

3. Supplement

### 1. Configuration Example According to One Embodiment

(1-1. Configuration Example of System)

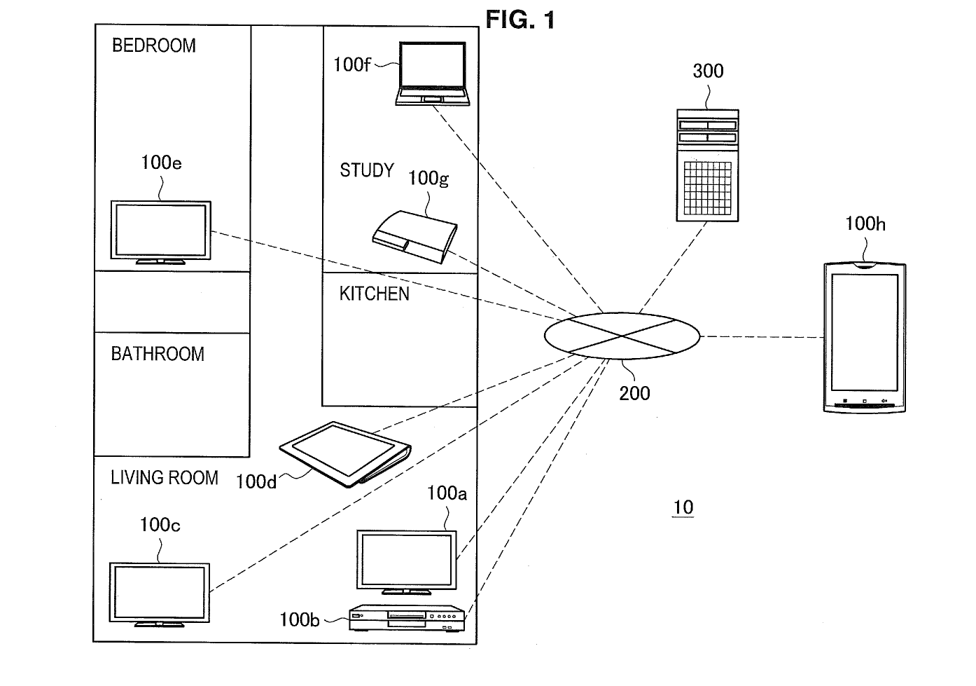

FIG. 1 is a diagram showing a configuration example of a system according to an embodiment of the present disclosure. Referring to FIG. 1, a system 10 includes an electronic device 100 and a network 200 to which the electronic device 100 is connected. The system 10 may further include a server 300 connected to the network 200.

The electronic device 100 is a device used by a user. The system 10 may include multiple electronic devices 100. FIG. 1 shows, as examples of the electronic devices 100, TV's 100a, 100c, and 100e, a recorder 100b, a tablet terminal 100d, a PC 100f, a NAS 100g, and a smartphone 100h. Examples of the electronic devices 100 are not limited to those devices, and may include any other devices that are connectable to the network 200, such as a media player, a printer, a game console, an air-conditioning device, and a refrigerator. Most of the electronic devices 100 are placed inside the home (for example, living room, bedroom, and study), and there may be a device such as the smartphone 100h that is carried outside the home.

The network 200 is a wireless and/or wired network that connects the electronic devices 100 to each other. For example, the network 200 includes a LAN to which each of the devices placed inside the home is connected. Further, the network 200 may include the Internet, a mobile telephone network, and the like, to which the smartphone 100h that is carried outside the home and the server 300 are connected.

The server 300 provides an electronic device 100 with a service through the network 200. The server 300 is achieved by an information processing apparatus connected to the network 200, for example. The functions of the server 300 to be described later may be achieved by a single information processing apparatus, or may be achieved in cooperation with multiple information processing apparatuses connected through a wired or wireless network.

In the present embodiment, the system 10 achieves a function that an agent recognizes an electronic device 100 designated by a user. The agent is a function achieved by the server 300 or any one of the electronic devices 100, for example, and uniformly controls the electronic devices 100 on the network 200 in accordance with a user's instruction input. For example, in the example shown in the figure, the TV 100a, the recorder 100b, and the like may be uniformly controlled in accordance with the user's instruction input to the smartphone 100h. For example, in the case where the user performs an audio input such as “I want to watch the drama on TV in the living room”, the agent controls each device in accordance with the results obtained by interpreting the input, and causes the TV 100a to display the drama recorded on the recorder 100b, for example. Such an agent itself has already been widely known.

However, in order for the agent to control the electronic device 100 in accordance with the user's instruction input, it is necessary that the agent be able to recognize which one of the electronic devices 100 is designated by the instruction input. In the case where an electronic device 100 is connected to the network 200, the agent can uniquely identify the electronic device 100 using a protocol such as UPnP. It should be noted that the information that the agent can acquire for identifying the electronic device 100 is a model number of the device or an ID of a DLNA (registered trademark), and no information as to where the device is placed or what the device is called by the user is acquired.

Accordingly, prior to giving the agent the instruction input for actually controlling the electronic device 100, it is necessary that the user associate the information to be given to the agent for designating each electronic device 100 with the information being used by the agent for identifying the electronic device 100. Taking the case of the TV 100a as an example, the user starts a setting function on the TV 100a, and inputs a nickname of the TV 100a (for example, “TV in living room”). With the notification of information of the nickname from the TV 100a to the agent, the agent can associate the information of the ID used for identifying the TV 100a and the like with the nickname that the user uses for designating the TV 100a.

However, since different electronic devices 100 have different associating procedures in many cases, and it is not necessarily easy for the user to execute the procedures for all the necessary electronic devices 100. The insufficient usability in the setting operation has caused the case in which the agent is not sufficiently used even in the agent-available environment.

Accordingly, the present embodiment enables the agent to recognize a designated device by the agent executing an interactive procedure with the user. In this way, the procedure of the setting operation may be simplified, for example. Alternatively, even if the setting procedure is not performed, for example, the operation of the electronic device 100 through the agent may be performed at least temporarily. As a result, more users can use the agent easily.

(1-2. Configuration Examples of Devices)

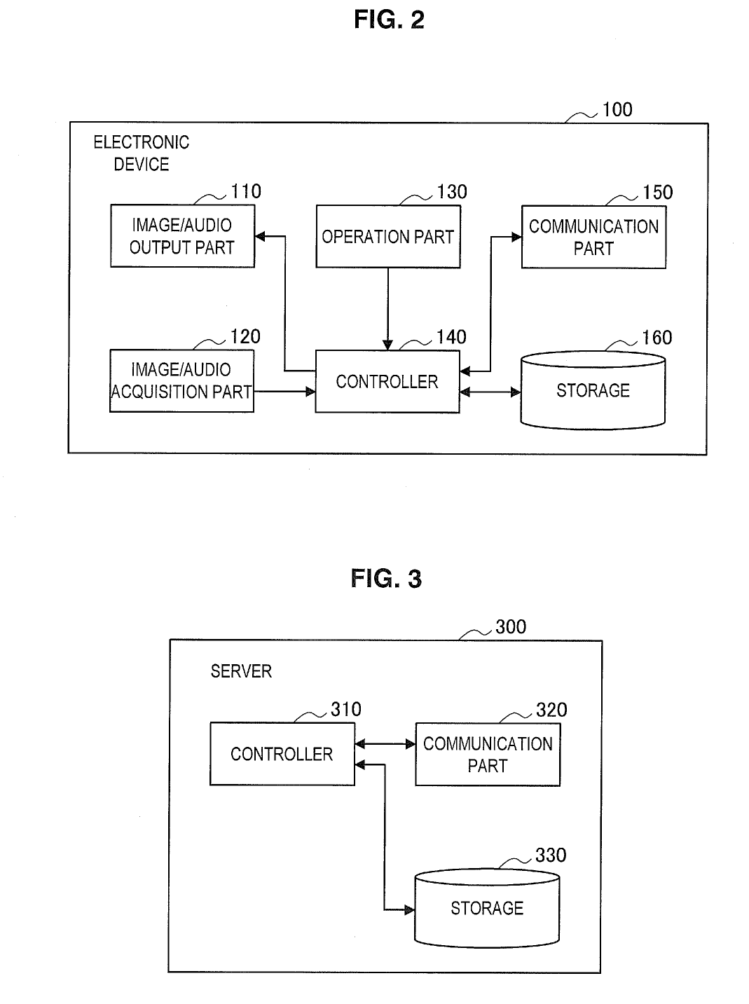

FIG. 2 is a block diagram showing a configuration example of an electronic device according to an embodiment of the present disclosure. Referring to FIG. 2, an electronic device 100 may include an image/audio output part 110, an image/audio acquisition part 120, an operation part 130, a controller 140, a communication part 150, and a storage 160. Note that the configuration shown in the figure is simplified for the description of the present embodiment, and the electronic device 100 may further include structural elements that are not shown in the figure. It should be noted that, since the structural elements that are not shown in the figure may already be known as general structural elements of each device, and hence, the detailed explanation is omitted here.

The image/audio output part 110 may be achieved by a display that outputs an image and a speaker that outputs an audio, for example. The display may be, for example, a liquid crystal display (LCD) or an organic electro-luminescence (EL) display, and displays electronically various types of images in accordance with control performed by the controller 140. The speaker outputs various types of audios in accordance with control performed by the controller 140. Note that the image/audio output part 110 may output one of the image and the audio depending on the type of the electronic device 100.

The image/audio acquisition part 120 may be achieved by a camera that acquires an image and a microphone that acquires an audio, for example. The camera electronically captures a real space using an image sensor such as a complementary metal oxide semiconductor (CMOS) and generates image data. The microphone records an audio such as user's utterances and generates the audio data, for example. The generated image and/or audio data is provided to the controller 140. Note that the image/audio acquisition part 120 may output one of the image and the audio depending on the type of the electronic device 100. Alternatively, the image/audio acquisition part 120 may not be provided.

The operation part 130 may be achieved by a touch panel, a keyboard, a mouse, a key pad, or a button, which acquires user's operation, for example. Information indicating the user's operation acquired by the operation part 130 is provided to the controller 140. In the electronic device 100, the user's instruction input may be acquired through the operation part 130, or may be acquired through the image/audio acquisition part 120 as an audio or a gesture. Accordingly, in the case where the electronic device 100 acquires the user's instruction input mainly by the operation part 130, the image/audio acquisition part 120 may not be provided, and, on the contrary, in the case where the electronic device 100 acquires the instruction input mainly by the image/audio acquisition part 120, the operation part 130 may not be provided.

The controller 140 may be achieved by a processor such as a central processing unit (CPU) and/or a digital signal processor (DSP) operating in accordance with a program stored in the storage 160. The controller 140 controls operations of the respective parts of the electronic device 100. For example, the controller 140 controls the image/audio output part 110 so as to output an image and/or an audio received through the communication part 150 or read from the storage 160. Further, the controller 140 controls the image/audio acquisition part 120 so as to acquire the image data and/or the audio data, processes the acquired data as necessary, and transmits the data through the communication part 150 or store the data in the storage 160. The controller 140 may execute those controls in accordance with the user's instruction input acquired through the operation part 130 or the image/audio acquisition part 120, for example.

The communication part 150 is a communication interface that supports wireless and/or wired communication scheme which configures the network 200. The communication part 150 may include, for example, a communication circuit, and an antenna or a port. Through the communication part 150, the controller 140 exchanges various types of information with another electronic device 100 on the network 200 or with the server 300.

The storage 160 may be achieved by semiconductor memory or a hard disk, for example. The storage 160 stores various types of data used in the electronic device 100 or generated in the electronic device 100. The storage 160 has a temporary storage area, and may temporarily store a program being executed by the controller 140, data acquired by the image/audio acquisition part 120, and data received by the communication part 150. Further, the storage 160 has a permanent storage area, and may store a program to be executed by the controller 140, various types of setting data, local content data output from the image/audio output part 110, data which is acquired by the image/audio acquisition part 120 and which the operation part 130 gives instructions to store, and the like.

FIG. 3 is a block diagram showing a configuration example of a server according to an embodiment of the present disclosure. Referring to FIG. 3, the server 300 may include a controller 310, a communication part 320, and a storage 330. Note that the configuration shown in the figure is simplified for the description of the present embodiment, and the server 300 may further include structural elements that are not shown in the figure. It should be noted that, since the structural elements that are not shown in the figure may already be known as general structural elements of the server, and hence, the detailed explanation is omitted here. Further, as described above, the server 300 may be achieved by a single information processing apparatus, or may be achieved in cooperation with multiple information processing apparatuses. Accordingly, the structural elements shown in the figure may be achieved by multiple information processing apparatuses dispersedly.

The controller 310 may be achieved by a processor such as a CPU and/or a DSP operating in accordance with a program stored in the storage 330. The controller 310 controls operations of the respective parts of the server 300. For example, the controller 310 refers to setting information and the like stored in the storage 330 as necessary and transmits information to the electronic device 100 on the network 200 through the communication part 320. The information may include a command to cause the electronic device 100 to execute a given operation. Further, the controller 310 transmits to another electronic device 100 information that may include a command on the basis of the result obtained by processing the information received from the electronic device 100 through the communication part 320. Alternatively, the controller 310 may update information such as setting information stored in the storage 330 on the basis of the results obtained by processing the information received from the electronic device 100 through the communication part 320.

The communication part 320 is a communication interface that supports wireless and/or wired communication scheme which configures the network 200. The communication part 320 may include, for example, a communication circuit, and a port or an antenna. Through the communication part 320, the controller 310 exchanges various types of information with an electronic device 100 on the network 200.

The storage 330 may be achieved by semiconductor memory or a hard disk, for example. The storage 330 stores various types of data used in the server 300 or generated in the server 300. The storage 330 has a temporary storage area, and may temporarily store a program being executed by the controller 310, data received by the communication part 320 from the electronic device 100, and data generated by the controller 310. Further, the storage 330 has a permanent storage area, and may store a program to be executed by the controller 310 and various types of setting data.

(1-3. Functional Configuration Example of Agent)

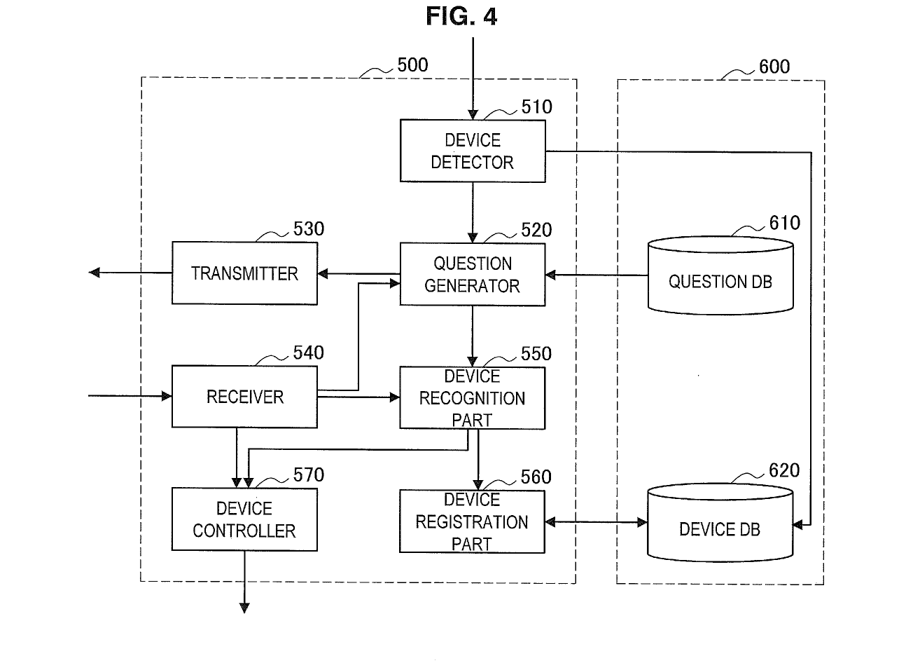

FIG. 4 is a block diagram showing a functional configuration example of an agent according to an embodiment of the present disclosure. Referring to FIG. 4, functions of the agent may be achieved by a control function 500 and a storage function 600. The control function 500 achieves a function of the agent by executing processing of reading, adding, and updating information stored by the storage function 600. The control function 500 and the storage function 600 may be achieved by the controller 310 and the storage 330 of the server 300, respectively, for example. Alternatively, the control function 500 and the storage function 600 may also be achieved by the controller 140 and the storage 160 of any one of the electronic devices 100, respectively. The control function 500 may be achieved by the electronic device 100 and the storage function 600 may be achieved by the server 300, in a dispersed manner.

To be more specific, for example, in the system 10, the control function 500 and the storage function 600 of the agent may be achieved in the server 300. In this case, the smartphone 100h, which is one of the electronic devices 100, may show information from the agent to the user, and may provide the user with a user interface for acquiring an instruction input from the user to the agent. Alternatively, in the system 10, the control function 500 and the storage function 600 of the agent may be achieved in the smartphone 100h (or may be achieved in another electronic device 100). In this case, the smartphone 100h itself may provide a user interface.

Note that, in the case where the electronic device 100 can achieve the functions of the agent, the system 10 may not include the server 300. Alternatively, the functions of the agent may be achieved by the server 300 and also by the electronic device 100. In the case where the server 300 is communicable with the network 200, the functions of the agent may be achieved by the server 300, and otherwise by the electronic device 100 instead.

The control function 500 includes a device detector 510, a question generator 520, a transmitter 530, a receiver 540, a device recognition part 550, a device registration part 560, and a device controller 570. The storage function 600 includes a question DB 610 and a device DB 620. Hereinafter, each of the parts will be described.

(Device Detector)

The device detector 510 detects an electronic device 100 connected to the network 200. The device detector 510 searches electronic devices 100 on the network 200 in accordance with a protocol such as UPnP, and uniquely identifies a device that is found using an ID of a DLNA (registered trademark), for example. The ID may be automatically allocated when the electronic device 100 is connected to the network 200, and may be stored in the storage 160 of the electronic device 100. The device detector 510 may add the information of the electronic device 100 that is uniquely identified to the device DB 620. At this point, no information as to where the electronic device 100 is placed or what the electronic device 100 is called by the user is not registered in the device DB 620.

(Question Generator)

The question generator 520 generates a question for causing the electronic device 100 detected by the device detector 510 to perform an output. The question generator 520 generates a question by referring to the question DB 610, for example. The question may be the one whose correct answer is a finite answer. The question generator 520 may generate questions in sentences and in choices. For example, the question sentence may be an audio or a text image of “What is on the screen?”, and the choices may be images of objects of animals and the like. In this case, the question generator 520 provides the device recognition part 550 with information of a correct answer to a question that is set in advance. Alternatively, the question generator 520 may generate a question that can obtain a correct answer by executing a given command in the electronic device 100. In this case, the device recognition part 550 acquires information of the correct answer by a response from the electronic device 100. As described below, in the case where questions are output from multiple electronic devices 100, correct answers to the questions may vary from one electronic device 100 to another.

(Transmitter)

The transmitter 530 transmits a command to cause a question generated by the question generator 520 to be output. For example, in the case where the questions are generated as a question sentence and choices, a command to cause the question sentence (for example, an audio or a text image of “What is on the screen?”) to be output may be transmitted to an electronic device 100 (for example, smartphone 100h) that provides a user interface. In the case where the control function 500 is achieved by an electronic device 100 and the electronic device 100 itself provides the user interface, the question sentence is internally transmitted to the image/audio output part 110 of the electronic device 100. On the other hand, a command to cause the choices (for example, images of objects of animals and the like) to be output may be transmitted to another electronic device 100. Note that examples of questions to be transmitted to the electronic device 100 and a timing at which a question is transmitted will be described later.

(Receiver)

The receiver 540 receives a user's answer to a question output in accordance with a command transmitted from the transmitter 530. The answer may be received as data indicating an audio or a gesture acquired by the image/audio acquisition part 120 of the electronic device 100, for example. Alternatively, the answer may be received as data indicating a user's operation acquired by the operation part 130 of the electronic device 100. The answer is acquired by the electronic device 100 (for example, smartphone 100h) that provides a user interface, and transmitted to the receiver 540. The electronic device 100 that provides a user interface may be a mobile device that is present in the vicinity of a user, for example. In the case where the control function 500 is achieved by an electronic device 100 and the electronic device 100 itself provides the user interface, the answer is internally received from the image/audio acquisition part 120 or the operation part 130 of the electronic device 100. Alternatively, the answer may be received from another electronic device 100. Note that, in this case, the next recognition processing performed in the device recognition part 550 may be executed regardless of whether the electronic device 100 which has received the answer is the same as the electronic device 100 which has output the question. Further, in the case where a correct answer to the question is obtained by executing a given command in the electronic device 100, the receiver 540 may receive information indicating the correct answer from the electronic device 100.

In addition, the receiver 540 may receive, followed by or together with the answer mentioned above, information to be given to the agent when the user designates an electronic device 100, such as the nickname of the electronic device 100. The information may be provided to the device registration part 560. Further, the receiver 540 may receive a user's instruction input before or after the answer or together with the answer. In the case where the device designated by the instruction input has been recognized by the answer received before or after the instruction input or has already been registered in a device DB together with information such as a nickname, the receiver 540 may provide the information of the instruction input to the device controller 570. Otherwise, the receiver 540 may temporarily leave the instruction input pending, and may start generation of a question performed by the question generator 520 and transmission of a command performed by the transmitter 530. After the designated device is recognized on the basis of the answer to the question, the instruction input may be provided to the device controller 570.

(Device Recognition Part)

The device recognition part 550 recognizes whether a user designates an electronic device 100 by comparing a correct answer to a question provided by the question generator 520 or the electronic device 100 with an answer received by the receiver 540. In the case where the correct answer to the question matches the answer, since it can be determined that the user is answering the question output from the electronic device 100, it can be recognized that the user designates the electronic device 100. Further, in the case where questions are output from multiple electronic devices 100, since questions vary from one electronic device 100 to another as described above, which of the electronic devices 100 the user designates can be recognized depending on a correct answer of which electronic device 100 the received answer matches.

(Device Registration Part)

The device registration part 560 acquires, from the device recognition part 550, information of an electronic device 100 that a user designates, and registers the electronic device 100 in the device DB 620 in association with information provided by the receiver 540 and given to an agent when the user designates the electronic device 100. After the registration, the user can control a desired electronic device 100 through the agent without another question and answer procedure, by allowing information such as the nickname of the electronic device 100 to be included in the instruction input. In the course of registration, the device registration part 560 may make a request to the user for additional information such as a nickname of the electronic device 100. Alternatively, the device registration part 560 may automatically acquire detailed position information of the user detected by a home sensor network, and may register the position information in the device DB 620 in association with an electronic device 100.

(Device Controller)

The device controller 570 controls an electronic device 100 in accordance with an instruction input received by the receiver 540. Except for the case of the electronic device 100 achieving the control function 500, since a device to be controlled is a different device from the device achieving the agent, the device controller 570 remotely controls a target electronic device 100 through the network 200. The device controller 570 specifies an electronic device 100 to be controlled by using information included in an instruction input and referring to the device DB 620. Alternatively, the device controller 570 specifies, as a device to be controlled, an electronic device designated by a user, the electronic device being recognized by the device recognition part 550.

(Question DB)

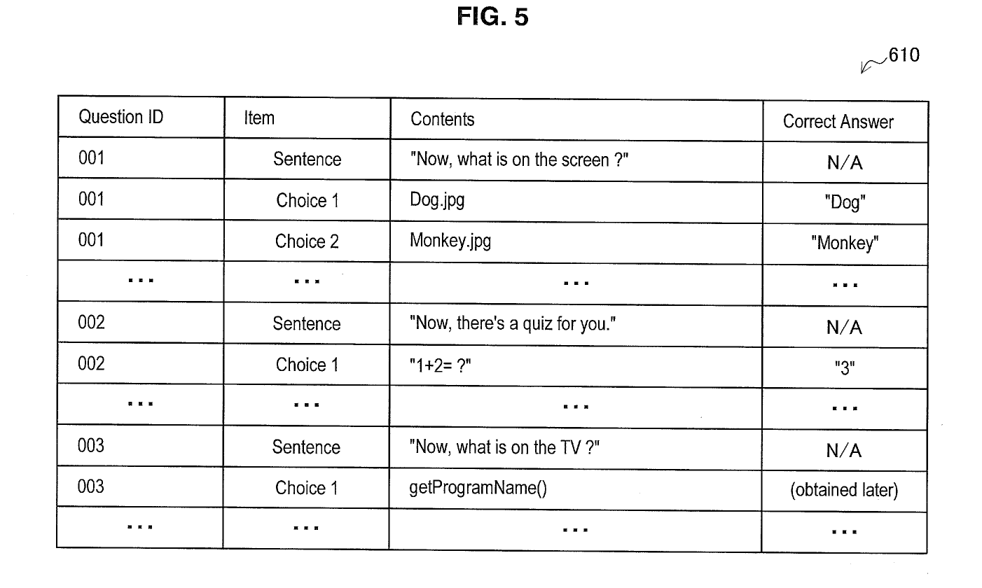

FIG. 5 shows examples of contents of the question DB 610. In the examples shown in the figure, the question DB 610 includes categories of “Question ID”, “Item”, “Contents”, and “Correct Answer”. “Question ID” represents an ID given to each of a series of questions including question sentences and choices. “Item” includes question sentences and choices, for example. For example, a question sentence is output as an audio or a text image from an electronic device 100 that functions as a user interface, urges to answer the question, and designates how to respond to the question. Multiple choices may be prepared in response to a question sentence. For a question ID “001” of the example shown in the figure, in response to the question sentence “Now, what is on the screen?”, some choices are prepared, such as “dog.jpg” (an image of a dog) and “cat.jpg” (an image of a cat). A correct answer represents an answer that is correct to be answered by a user when each of the choices is output as a question from the electronic device 100. For example, in the case where “dog.jpg” (an image of a dog) is displayed on the electronic device 100, the user is to answer “Dog”. Note that multiple correct answers may be prepared taking into consideration individual differences of users in recognition and vocabulary, such as “Puppy” and “Bow-wow”. Note that the figure shows examples of other questions, and those examples will be described specifically later.

(Device DB)

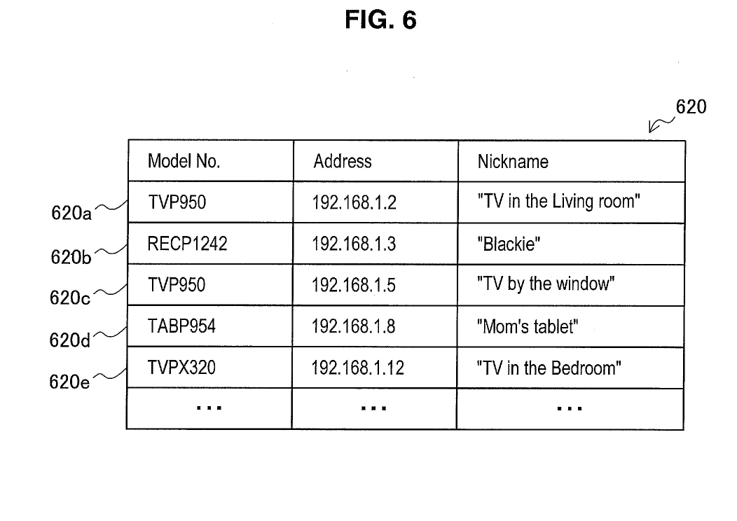

FIG. 6 shows examples of contents of the device DB 620. In the examples shown in the figure, the device DB 620 includes categories of “Model No.”, “Address”, and “Nickname”. “Model No.” represents a model number of each of the electronic devices 100. “Address” represents an ID for uniquely identifying an electronic device 100 on the network 200. Those pieces of information may be automatically acquired and set in accordance with a protocol such as UPnP when the electronic device 100 is connected to the network 200, for example.

However, there are some cases where those pieces of information do not specify which one of the electronic devices 100 a user designates. For example, a record 620b is a record of the recorder 100b and a record 620d is a record of the tablet terminal 100d, but it is difficult for the user to recognize the differences between the model numbers and addresses of those records. For example, if the question of “Is it RECP1242 that you designate?” is asked to the user from the agent, the user in many cases does not know which device the model number indicates.

In addition, a record 620a is a record of the TV 100a and a record 620c is a record of the TV 100c, but since those TV's have the same model numbers, it is only “Address” that is different between the records. Since the addresses are allocated automatically, for example, it is extremely difficult for the user to distinguish the two devices on the basis of the difference in the addresses. Further, even if a room in which the TV's are placed has been found in some way, since the TV's are both placed in the living room, it is difficult to specify which of the TV 100a and the TV 100c is designated when the user calls “TV in the living room”.

Accordingly, in the present embodiment, the device registration part 560 uses the category of “Nickname” set in the device DB 620. For example, after an electronic device 100 designated by the user is recognized through the question and answer procedure, the nickname may be set by the user inputting a nickname for designating the device. Since the user can freely input a nickname regardless of a room in which the device is placed, it is also possible to give a nickname of “Blackie” to the recorder 100b having a black casing and to give a nickname of “Mom's tablet” to the tablet terminal 100d. After the registration performed by the device registration part 560, the device controller 570 is capable of specifying the electronic device 100 to be controlled using those nicknames included in the user's instruction input.

(1-4. Example of Processing Flow of Agent)

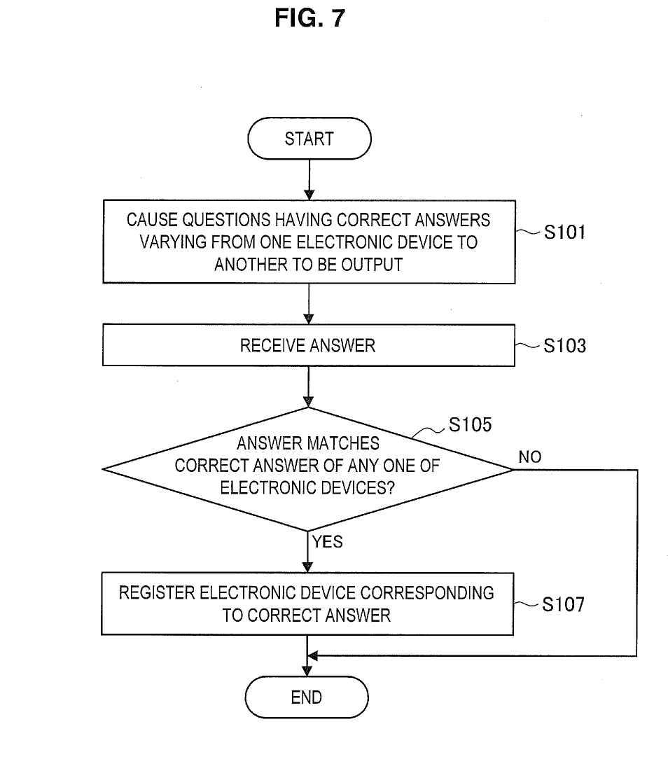

FIG. 7 is a flowchart showing an example of processing performed by an agent according to an embodiment of the present disclosure. Among functions of the agent according to the present embodiment, FIG. 7 illustrates processing of transmitting commands to multiple electronic devices 100, recognizing which of those devices a user designates, and registering the device designated by the user. Now, as has already been described, the agent may also achieve various functions other than the functions according to the processing shown in the figure.

First, the agent causes electronic devices 100 to output questions having correct answers which vary from one electronic device 100 to another (Step S101). To be more specific, first, the device detector 510 detects electronic devices 100 connected to the network 200. The electronic devices 100 to be detected may be all of the electronic devices 100 found on the network 200 with a search using a protocol such as UPnP, for example. Alternatively, an electronic device 100 to be detected may be limited to the device in which the image/audio output part 110 is started and which is capable of outputting information to the user, out of the electronic devices 100 found on the network 200. Further, the electronic device 100 to be detected may also be an electronic device 100 that has not yet been registered in the device DB 620, out of any of the electronic devices 100 mentioned above.

In addition, in the above Step S101, the question generator 520 generates a question to be transmitted to the electronic device 100 detected by the device detector 510. As has already been described, in the case where questions are output from multiple electronic devices 100, the correct answers to the questions may vary from one electronic device 100 to another. The question generator 520 may generate a question by referring to the question DB 610. The transmitter 530 transmits to each electronic device 100 a command to cause the question to be generated by the question generator 520. In accordance with the command transmitted by the transmitter 530, an electronic device 100 to be recognized, such as the TV 100a, the recorder 100b, or the TV 100c, outputs an image or an audio corresponding to each correct answer. Further, an electronic device 100 which functions as a user interface, such as the smartphone 100h, outputs a question sentence. Note that, as shown in the example described below, the question sentence may be output also from the electronic device 100 to be recognized.

Next, the agent receives a user's answer to the question output from the electronic device 100 (Step S103). To be more specific, the receiver 540 receives a user's answer from any one of the electronic devices 100. The receiver 540 may receive an answer from an electronic device 100 which functions as a user interface, such as the smartphone 100h, may receive an answer from an electronic device 100 to be recognized, such as the TV 100a, the recorder 100b, or the TV 100c, or may also extract an answer from pieces of information received from both of those devices. The receiver 540 receives an answer as audio data, for example. Alternatively, the receiver 540 may also receive an answer as text data, and may also receive an answer as an operation input using a keyboard or a button or as information such as a gesture. The receiver 540 provides the device recognition part 550 with the received information.

Next, the agent determines whether the user's answer matches a correct answer to a question on any one of the electronic devices 100 (Step S105). To be more specific, the device recognition part 550 compares a correct answer to a question on each electronic device 100 with an answer provided from the receiver 540. In the present embodiment, information of the correct answer to the question is provided from the question generator 520, for example. For example, in the case where the question generator 520 generates a question by referring to the question DB 610 like the example shown in FIG. 5 and the question of the question ID “001” is employed, the question generator 520 may provide the device recognition part 550 with information such as “Correct answer on TV 100a is ‘Dog’” and “Correct answer on recorder 100b is ‘Monkey’”.

In Step S105, in the case where the user's answer matches any one of the correct answers to the questions on the electronic devices 100, the device registration part 560 registers the electronic device 100 corresponding to the correct answer in the device DB 620 (Step S107). For example, in the example described above, in the case where the user's answer is “Dog”, the device registration part 560 may register the TV 100a in the device DB 620. To be more specific, for example, the device registration part 560 associates newly acquired nickname, position information, and the like with the record of the TV 100a already registered in the device DB 620 in association with information such as an address acquired automatically. Here, the device registration part 560 may additionally make a request to the user for information such as a nickname, for example.

Note that, in Step S107, the already-registered information on the electronic device 100 such as a nickname and position information may be replaced with newly acquired nickname and position information. Further, as has already been described, in Step S107, together with or instead of the registration of a device performed by the device registration part 560, the device controller 570 may control the electronic device 100. On the other hand, in the case where the user's answer does not match any of the correct answers to the questions in Step S105, or in the case where the user's answer is not acquired, the function of Step S107 is not executed, and the processing ends. Alternatively, in this case, a question may be output again using a function of the question generator 520 and the like.

### 2. Examples of Specific Utilization Forms

### 2-1. First Example

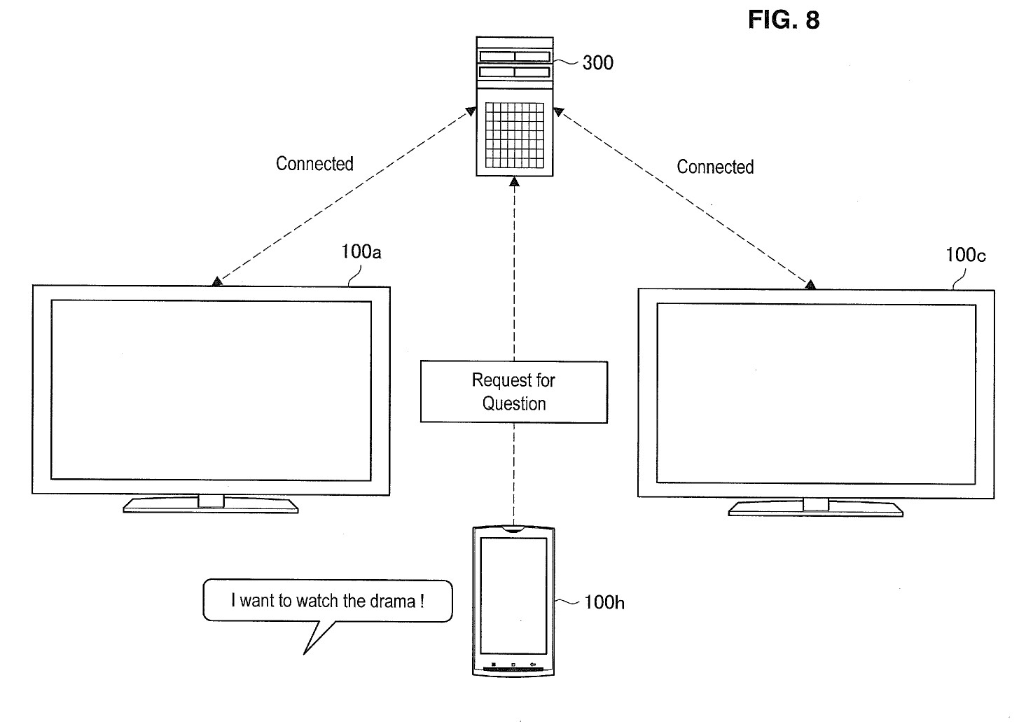

With reference to FIGS. 8 to 12, there will be described a first example of a specific utilization form according to an embodiment of the present disclosure.

In the first example, first, as shown in FIG. 8, processing starts when a user gives an instruction input of “I want to watch the drama!”. The instruction input may be acquired, as an audio of an utterance by the user, by the image/audio acquisition part 120 (to be more specific, microphone) of the smartphone 100h that functions as a user interface. The smartphone 100h transmits the acquired information to the server 300. The server 300 interprets the information as a request to output a question.

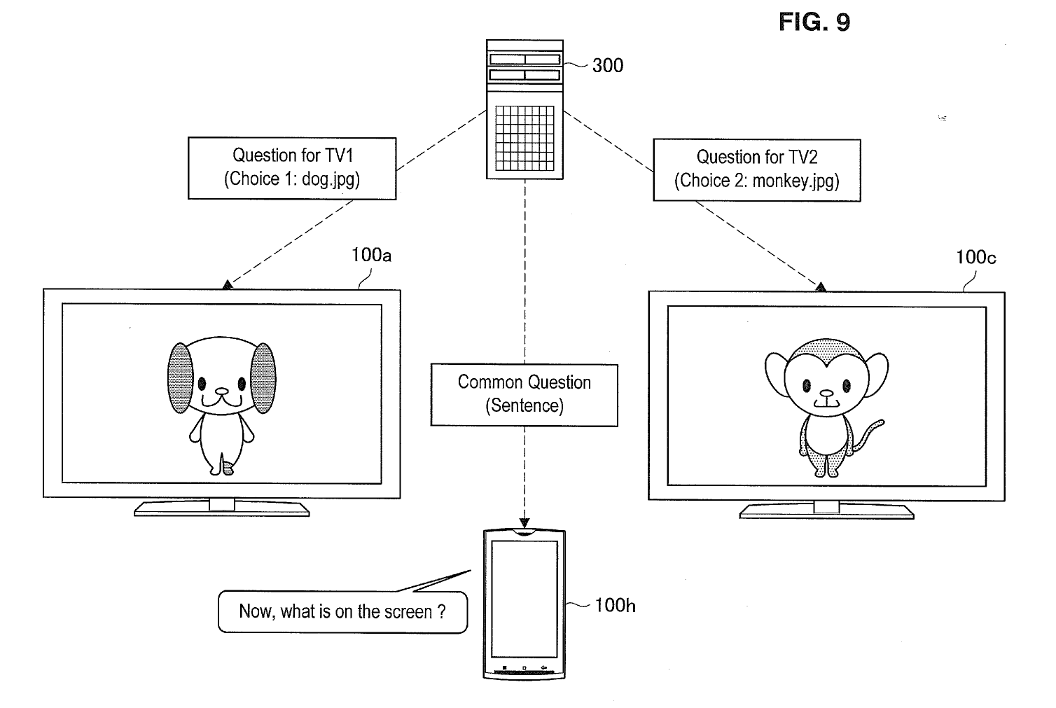

Here, the server 300 detects the TV 100a and the TV 100c as devices uniquely identified on the network 200. Accordingly, as shown in FIG. 9, the server 300 transmits a command to output a question to each of the TV 100a and the TV 100c. In addition, the server 300 transmits a command to output a question sentence to the smartphone 100h. To be more specific, a command to display a choice 1 (dog.jpg: an image of a dog) is transmitted to the TV 100a (TV1), a command to display a choice 2 (monkeyjpg: an image of a monkey) is transmitted to the TV 100c (TV2), and a command to cause a question sentence (audio of “Now, what is on the screen?”) to be output is transmitted to the smartphone 100h.

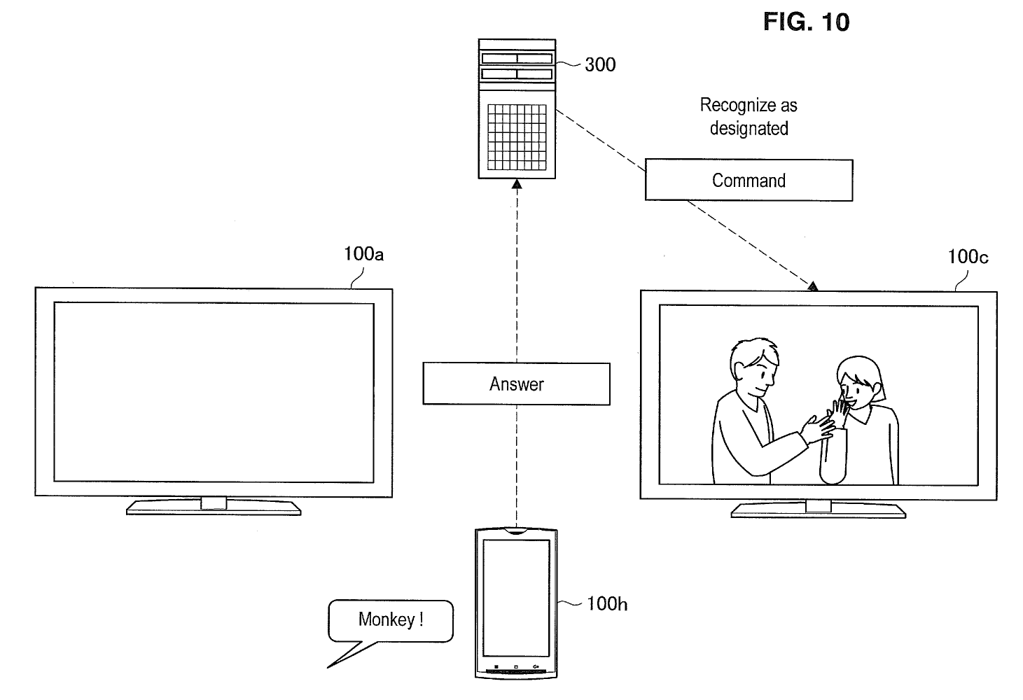

In response to the question, as shown in FIG. 10, in the case where an answer of “Monkey!” is acquired from the user, the server 300 recognizes the TV 100c (TV2) which has output the question (choice 2: an image of a monkey) in which the answer of “Monkey” is the correct answer as the device designated by the user, and the server 300 transmits to the TV 100c a control command in accordance with the instruction input (“I want to watch the drama!”) of the user that has been acquired in advance. In this way, a drama is shown on the TV 100c, and the user can watch and listen to the desired drama. Note that, as the example shown in the figure, the answer of the user may be given to the smartphone 100h as an audio, for example.

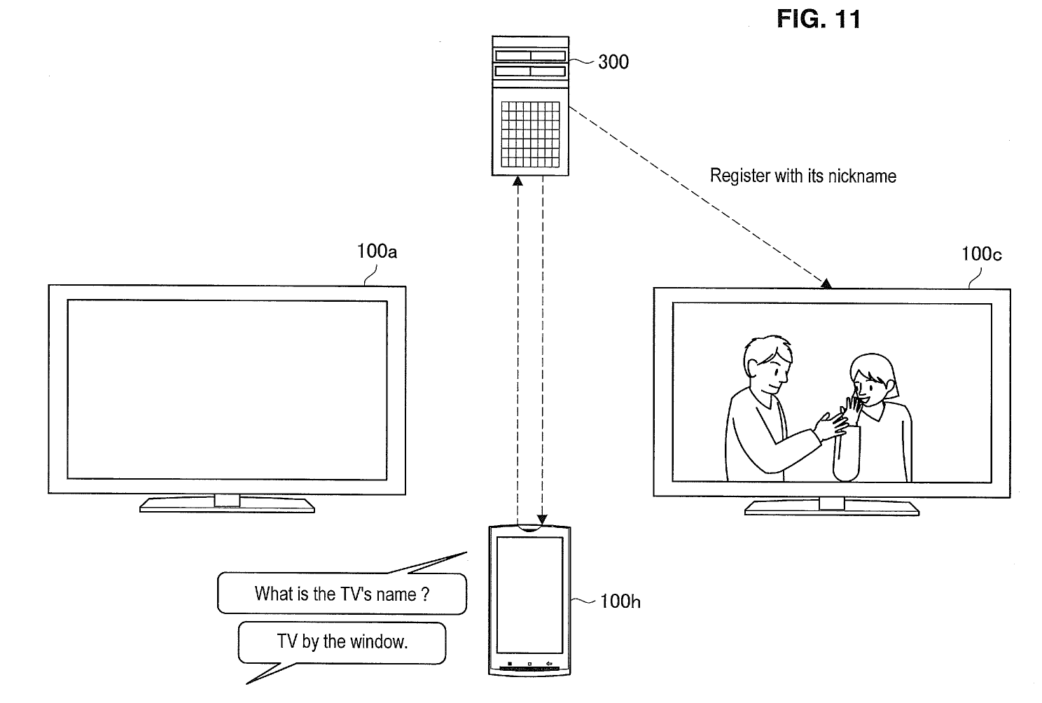

In addition, as shown in FIG. 11, the server 300 may also cause the smartphone 100h to output an additional question (“What is the TV's name?”) that asks the nickname of the designated TV 100c. In the case where an answer (“TV by the window”) is obtained from the user with respect to the question, the server 300 registers the TV 100c with the nickname in the device DB 620. As has already been described, instead of asking the user the nickname, the server 300 may also register the TV 100c with detailed position information of the user detected by a home sensor network, for example.

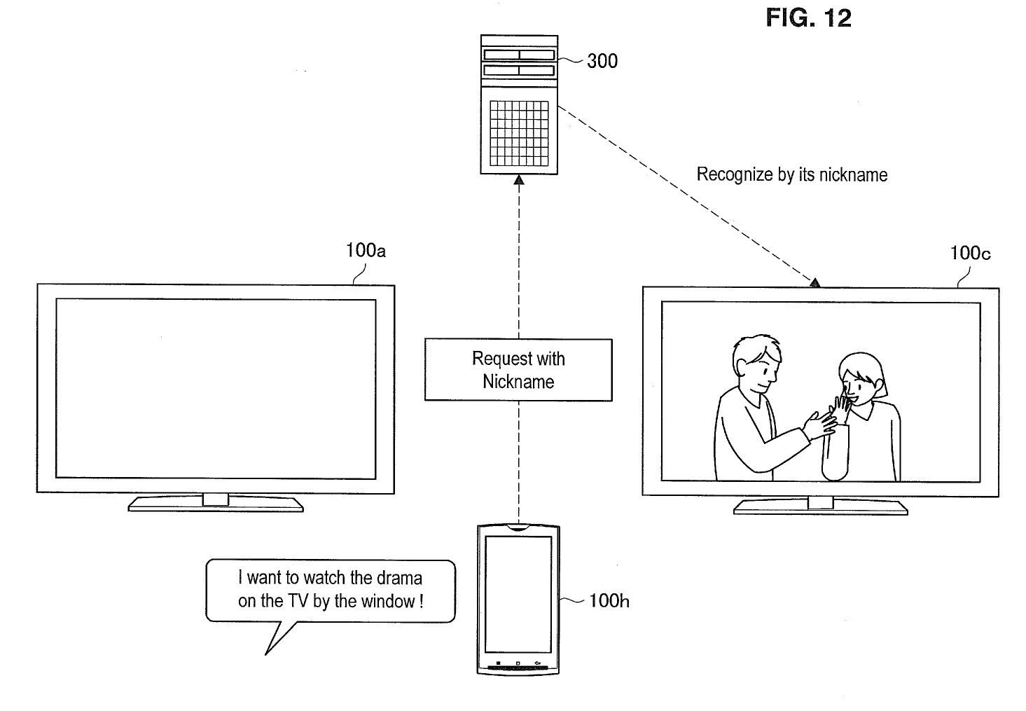

Using the procedure as described above, after the above processing, as shown in FIG. 12, the server 300 automatically recognizes the TV 100c as a device designated by the user when there is an instruction input such as “I want to watch the drama on the TV by the window!” acquired together with information (for example, nickname) indicating that the user designates the TV 100c, and the server 300 can automatically show the drama on the TV 100c. Alternatively, in the case where the TV 100c is registered with position information, if the user gives an instruction input in a state of being in the vicinity of the TV 100c, the server 300 acquires the position information of the user as information indicating that the user designates the TV 100c, and transmits a control command to show the drama on the TV 100c. In this case, the user may not include information such as a nickname in the instruction input.

In the first example described above, when the user gives an instruction input asking for some sort of function to the electronic device 100, the server 300 transmits to the electronic device 100 a command to cause a question to be output, and, on the basis of an answer that the user gives to the question, which device the user designates is recognized. After the device designated by the user has been recognized, the server 300 may transmit to the device a control command corresponding to the first instruction input given by the user. In addition, in order to simplify an instruction input after that, the server 300 may acquire the information for designating the device from the user or automatically, and may register the information in association with the electronic device 100.

### 2-2. Second Example

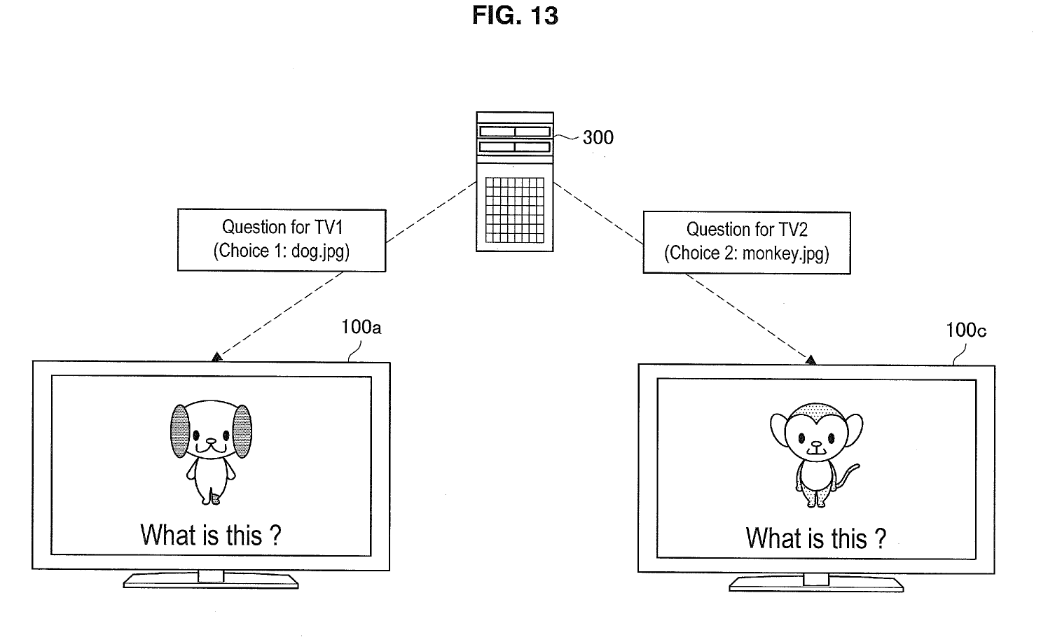

Subsequently, with reference to FIG. 13, there will be described a second example of a specific utilization form according to an embodiment of the present disclosure. The second example differs from the first example in that a question sentence is not output from the smartphone 100h, but from the TV's 100a and 100c. In this way, an embodiment of the present disclosure does not necessarily necessitate an electronic device 100 (for example, smartphone 100h) that functions as a user interface, and, for example, an electronic device 100 itself, which is also a device to be recognized, may output a question including a question sentence to the user and may acquire an answer from the user.

For example, in the example shown in the figure, the server 300 transmits to each of the TV 100a and the TV 100c a command to cause a question including a question sentence to be output. To be more specific, a command to display a choice 1 (dog.jpg: an image of a dog) and a question sentence (“What is this?”) is transmitted to the TV 100a (TV1), and a command to display a choice 2 (monkeyjpg: an image of a monkey) and a question sentence (“What is this?”) is transmitted to the TV 100c (TV2). Although not shown, the user's answers to those questions may also be acquired by the image/audio acquisition parts 120 (to be more specific, microphones) of the TV's 100a and 100c, for example.

Provided that the user designates one of electronic devices 100 that are recognizable by the series of processes performed by the server 300, at least one of the electronic devices 100 should be able to output a question to transmit the question to the user, and to acquire an answer from the user. Note that, for example, in the case where any one of the electronic devices 100 is not able to acquire an answer of the user (in the case of not including the image/audio acquisition part 120, for example) there may be used an electronic device 100 that functions as a user interface, such as the smartphone 100h.

### 2-3. Third Example

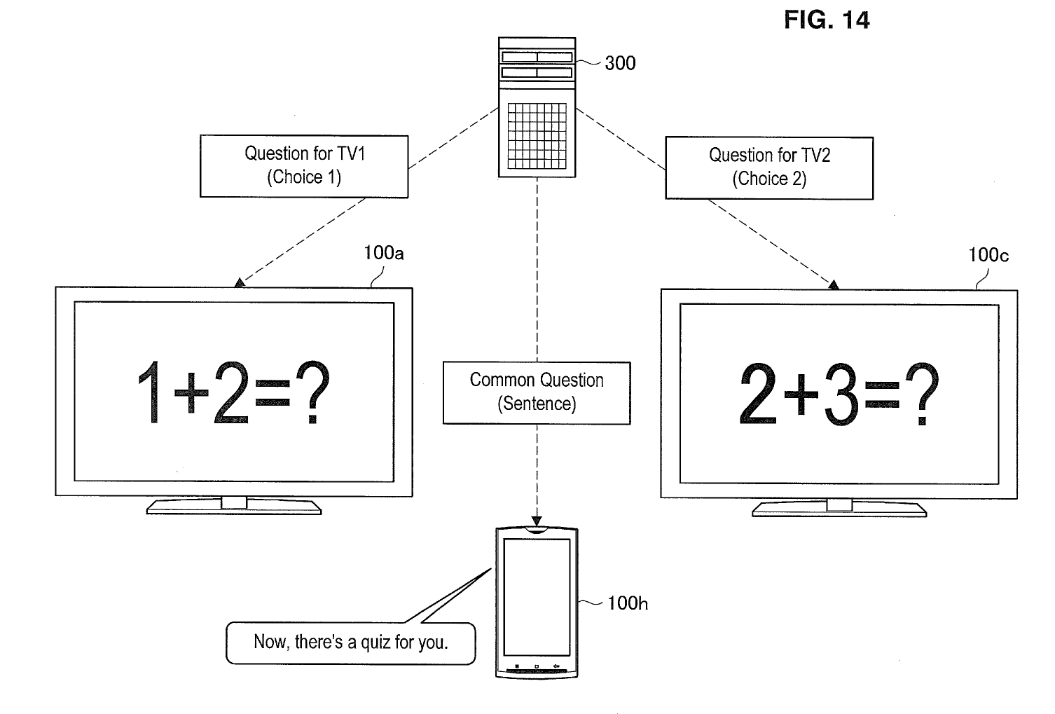

Subsequently, with reference to FIG. 14, there will be described a third example of a specific utilization form according to an embodiment of the present disclosure. The third example differs from the first example in contents of a question output from an electronic device 100. Note that this example corresponds to the question of the question ID “002” illustrated in an example of the question DB 610 shown in FIG. 5. In the example shown in the figure, simple mathematical calculations may be used as questions which the server 300 causes the TV's 100a and 100c to display. To be more specific, the server 300 transmits a command to cause a choice 1 question (“1+2=?”) to be displayed on the TV 100a (TV1), transmits a command to cause a choice 2 question (“2+3=?”) to be displayed on the TV 100c (TV2), and transmits a command to cause a question sentence (audio of “Now, there's a quiz for you”) to be output to the smartphone 100h.

To each of the questions, the user may give an answer such as “3” or “5” to the smartphone 100h as an audio of an utterance. Alternatively, the user may give the answer by an operation using number keys provided by the smartphone 100h. In this way, the types of questions output from an electronic device 100 according to an embodiment of the present disclosure may vary over a wide range. The question may be those making the user answer a color of an entire screen or an object displayed on the screen, and a change of those displays, such as the number of blinkings. Further, the question is not limited to a visual question, and may be a question using an audio, for example. To be more specific, the simple mathematical calculation may be output using audio, or another simple question such as “What day comes after Tuesday?” may also be output.

### 2-4. Fourth Example

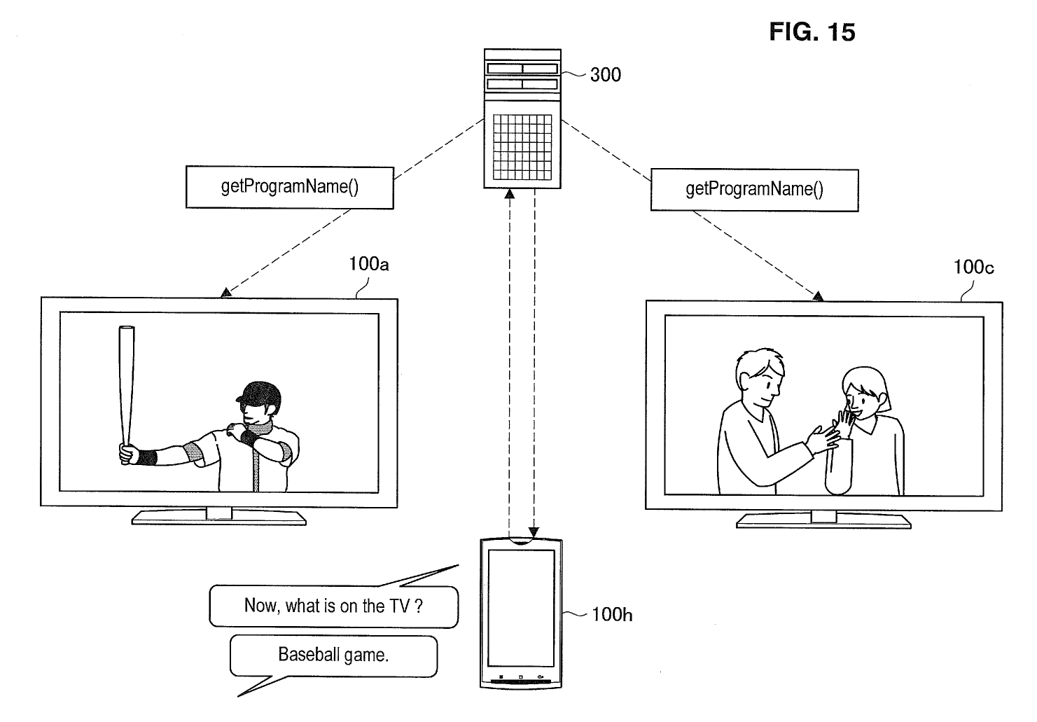

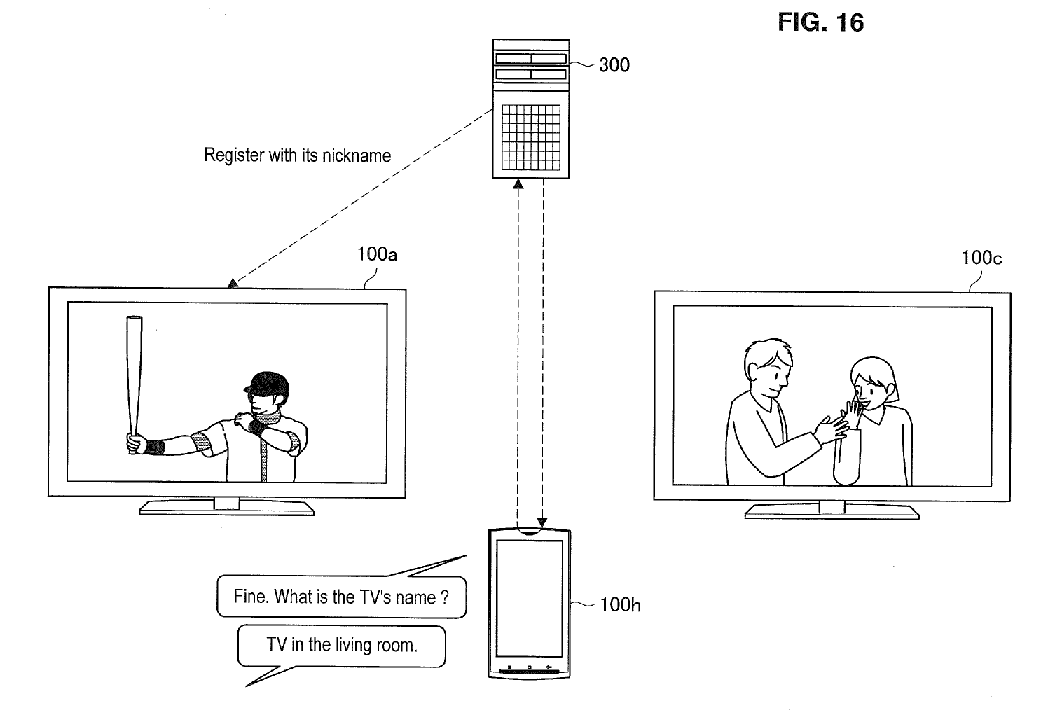

Subsequently, with reference to FIG. 15 and FIG. 16, there will be described a fourth example of a specific utilization form according to an embodiment of the present disclosure. The fourth example also differs from the first example in contents of a question output from an electronic device 100. Note that this example corresponds to the question of the question ID “003” illustrated in an example of the question DB 610 shown in FIG. 5.

In this example, as shown in FIG. 15, the server 300 causes each of the TV's 100a and 100c to execute a command of “getProgramName( )”. The commands are used for acquiring names of programs received by the TV's 100a and 100c and causing the names of the programs to be sent back to the server 300. As a result of the TV's 100a and 100c executing those commands, information of “Baseball game” is sent back from the TV 100a to the server 300, and information of “Drama” is sent back from the TV 100c to the server 300. The server 300 handles those pieces of information as correct answers to the output question. Note that the question may include programs themselves that the TV's 100a and 100c shows on the screen. On the other hand, the server 300 transmits to the smartphone 100h a command to cause a question sentence (audio of “Now, what is on the TV?”) to be output.

Here, in the case where an answer of “Baseball game” is given by the user to the smartphone 100h, the server 300 recognizes the TV 100a as a device designated by the user. In addition, as shown in FIG. 16, the server 300 may transmit to the smartphone 100h a command to cause an additional question (“Fine. What is the TV's name?”) for asking the nickname of the TV 100a to be output. In the case where an answer (“TV in the living room”) is acquired to this question from the user, the server 300 registers the TV 100a with this nickname in the device DB 620. As has already been described, instead of asking the user the nickname, the server 300 may also register the TV 100a with detailed position information of the user detected by a home sensor network, for example.

In the example described above, the exchange between the agent and the user for recognizing and registering the TV 100a may be executed when the user operates and uses the TV 100a directly (not through the agent), for example. That is, if the user can directly operate and use the TV 100a, the user does not have to execute separately the procedure for registering the electronic device 100. Further, since the program itself shown on the TV 100a constitutes the question, the possibility of disturbing user's watching and listening to the program is low. As a result, only by casually answering the question from the agent during watching and listening to the TV 100a, the user can register the TV 100a with the nickname, and after that, can operate the TV 100a using an instruction input including the nickname to the agent.

### 2-5. Fifth Example

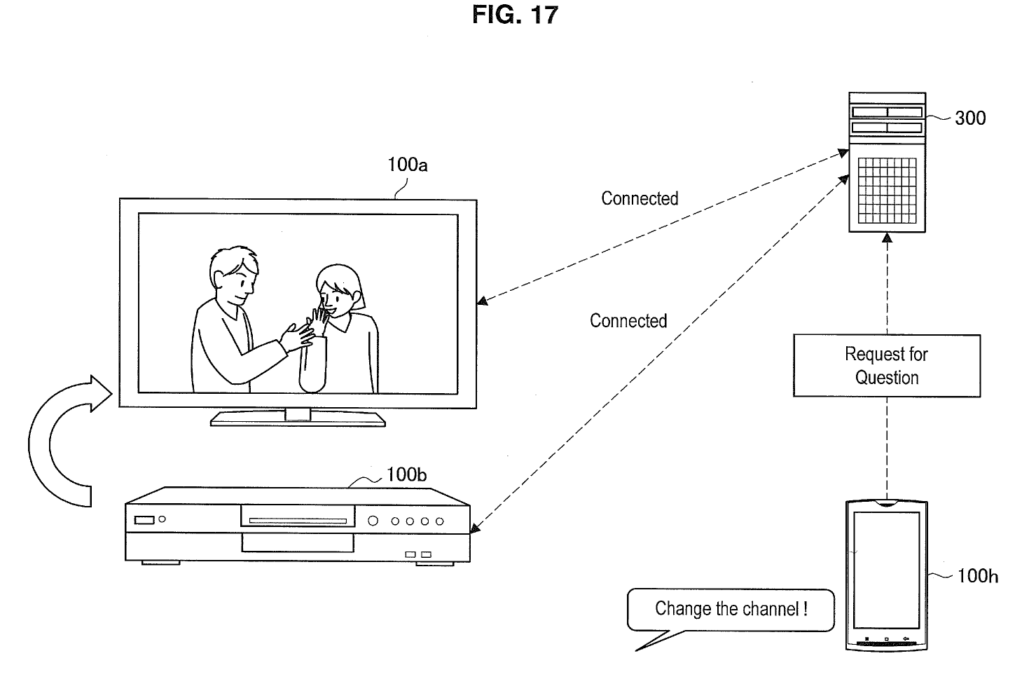

Subsequently, with reference to FIGS. 17 to 19, there will be described a fifth example of a specific utilization form according to an embodiment of the present disclosure. In the fifth example, as shown in FIG. 17, the TV 100a and the recorder 100b are connected to the network 200. The TV 100a and the recorder 100b each have a function of a tuner which receives broadcast waves, and are capable of setting channels independently. Further, the TV 100a is capable of acquiring signals of an image and an audio from the recorder 100b, and outputs in a switching manner the image and the audio using the broadcast waves received by the TV 100a itself and the image and the audio provided by the recorder 100b.

Let us assume that the user watches and listens to an image and an audio on the TV 100a in the state described above, and additionally gives an instruction input of “Change the channel!” to the smartphone 100h. In this case, as the controls according to the user's instruction input performed to the device, there may be two ways: changing of the channels received by the TV 100a; and the changing of the channels received by the recorder 100b.

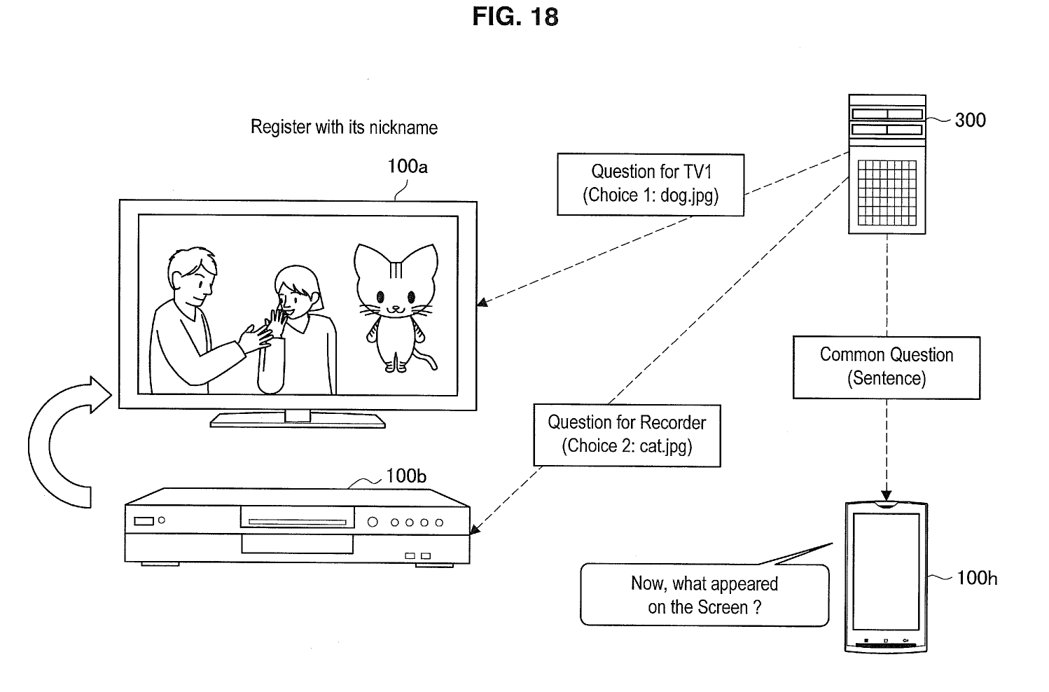

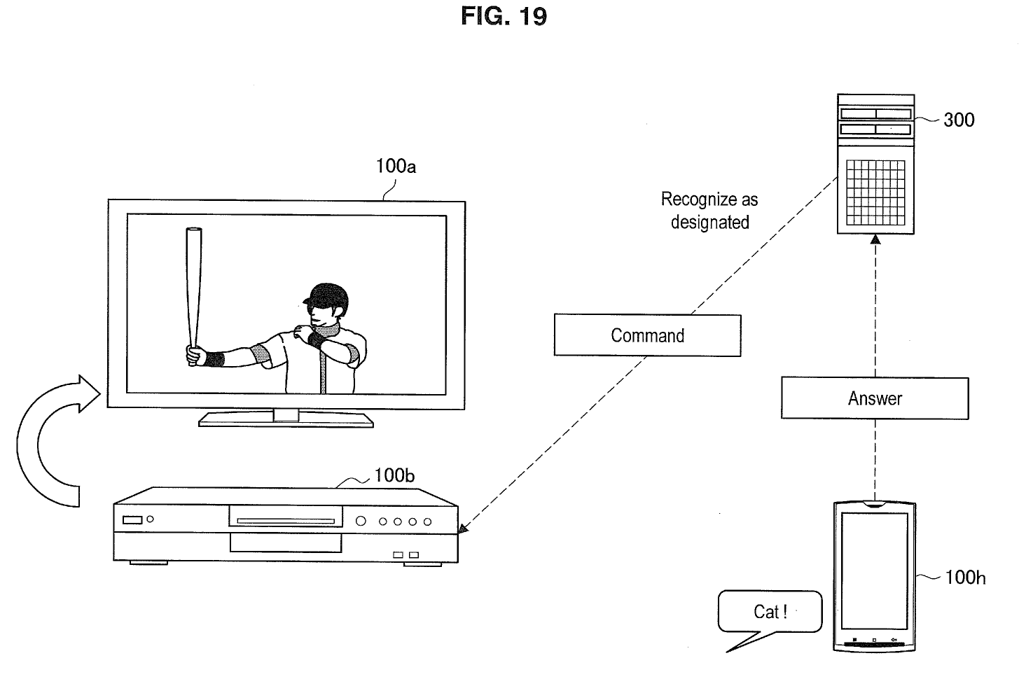

Accordingly, as shown in FIG. 18, the server 300 which has received the instruction input transmits to the TV 100a and the recorder 100b a command to cause choices of a question to be output. To be more specific, the server 300 transmits to the TV 100a a command to cause the choice 1 (dog.jpg: an image of a dog) to be displayed additionally on the screen, and transmits to the recorder 100b a command to cause the choice 2 (cat.jpg: an image of a cat) to be displayed additionally on the screen. In this way, in the example shown in the figure, since the TV 100a outputs the image and the audio provided by the recorder 100b, the image of a cat (cat.jpg) is displayed additionally on the screen of broadcast program shown on the TV 100a. Further, the server 300 transmits to the smartphone 100h a command to cause the question sentence (an audio of “Now, what appeared on the screen?”) to be output.

To this question, as shown in FIG. 19, in the case where an answer of “Cat!” is acquired from the user, the server 300 recognizes the recorder 100b which has output the question (choice 2: an image of a cat) in which the answer of “Cat” is the correct answer as the device designated by the user, and the server 300 transmits to the recorder 100b a command to change channels of broadcast waves received by a tuner. In this way, a channel of a broadcast program output from the TV 100a in accordance with signals provided from the recorder 100b is changed according to the user's instruction input.

### 3. Supplement

The embodiments of the present disclosure may include the information processing apparatus (server or electronic device), the system, the information processing method executed in the information processing apparatus or the system, the program for causing the information processing apparatus to function, and the non-transitory tangible media having the program recorded thereon, which have been described above, for example.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below:

(1) An information processing apparatus including:

a receiver configured to receive an answer of a user to a question output from at least one device which has been uniquely identified on a network; and

a device recognition part configured to recognize whether the user designates the device by comparing a correct answer to the question with the answer.

(2) The information processing apparatus according to (1),

wherein the receiver further receives information other than the answer indicating that the user designates the device, and

wherein the information processing apparatus further includes a device registration part configured to register the information in association with the device.

(3) The information processing apparatus according to (2),

wherein the receiver further receives an instruction input of the user together with the information, and

wherein the information processing apparatus further includes a device controller configured to control a device registered in association with the information in accordance with the instruction input.

(4) The information processing apparatus according to (2) or (3),

wherein the information includes a nickname given by the user to the device.

(5) The information processing apparatus according to any one of (2) to (4),

wherein the information includes position information of the user.

(6) The information processing apparatus according to any one of (2) to (5), further including

a transmitter configured to transmit to the device a command to cause the question to be output when the user directly operates and uses the device.

(7) The information processing apparatus according to any one of (1) to (6),

wherein the receiver receives an answer of a user to questions output from a plurality of devices which have been uniquely identified on a network, and

wherein the device recognition part recognizes which of the plurality of devices the user designates by comparing the answer with correct answers to the questions, the correct answers being different from each other between the plurality of devices.

(8) The information processing apparatus according to (7),

wherein the receiver further receives an instruction input of the user, and

wherein the information processing apparatus further includes
a transmitter configured to transmit to the plurality of devices a command to cause the questions to be output when the instruction input is received, and
a device controller configured to control a device which is recognized to be designated by the user, in accordance with the instruction input.
   (9) The information processing apparatus according to any one of (1) to (8),

wherein the receiver receives the answer as audio data.

(10) The information processing apparatus according to any one of (1) to (9), further including:

a question generator configured to generate the question, and notifies the device recognition part of a correct answer to the question; and

a transmitter configured to transmit to the device a command to cause the question to be output.

(11) The information processing apparatus according to any one of (1) to (9), further including

a transmitter configured to transmit to the device a command to cause a correct answer to a question to be output by the device to be transmitted,

wherein the receiver receives a correct answer sent back from the device in accordance with the command, and notifies the device recognition part of the correct answer.

(12) The information processing apparatus according to any one of (1) to (11),

wherein the receiver receives the answer from a mobile device, the mobile device being placed near the user and being different from the device.

(13) The information processing apparatus according to any one of (1) to (12), further including

a transmitter configured to transmit, to a mobile device placed near the user, a command to cause a question sentence of the question to be output.

(14) The information processing apparatus according to (13),

wherein the transmitter transmits a command to cause the question sentence to be output as an audio.

(15) The information processing apparatus according to any one of (1) to (12), further including

an output part configured to output a question sentence of the question to the user.

(16) The information processing apparatus according to any one of (1) to (11), further including

an acquisition part configured to acquire the answer,

wherein the receiver internally receives the answer from the acquisition part.

(17) An information processing method including:

receiving an answer of a user to a question output from at least one device which has been uniquely identified on a network; and

recognizing whether the user designates the device by comparing a correct answer to the question with the answer.

(18) A program for causing a computer to achieve

a function of receiving an answer of a user to a question output from at least one device which has been uniquely identified on a network, and

a function of recognizing whether the user designates the device by comparing a correct answer to the question with the answer.

What is claimed is:

1. An information processing apparatus comprising:
a receiver configured to receive an answer of a user to a question output from at least one device which has been uniquely identified on a network; and
a device recognition part configured to recognize whether the user designates the device by comparing a correct answer to the question with the answer.

2. The information processing apparatus according to claim 1,
wherein the receiver further receives information other than the answer indicating that the user designates the device, and
wherein the information processing apparatus further includes a device registration part configured to register the information in association with the device.

3. The information processing apparatus according to claim 2,
wherein the receiver further receives an instruction input of the user together with the information, and
wherein the information processing apparatus further includes a device controller configured to control a device registered in association with the information in accordance with the instruction input.

4. The information processing apparatus according to claim 2,
wherein the information includes a nickname given by the user to the device.

5. The information processing apparatus according to claim 2,
wherein the information includes position information of the user.

6. The information processing apparatus according to claim 2, further comprising
a transmitter configured to transmit to the device a command to cause the question to be output when the user directly operates and uses the device.

7. The information processing apparatus according to claim 1,
wherein the receiver receives an answer of a user to questions output from a plurality of devices which have been uniquely identified on a network, and
wherein the device recognition part recognizes which of the plurality of devices the user designates by comparing the answer with correct answers to the questions, the correct answers being different from each other between the plurality of devices.

8. The information processing apparatus according to claim 7,
wherein the receiver further receives an instruction input of the user, and
wherein the information processing apparatus further includes
a transmitter configured to transmit to the plurality of devices a command to cause the questions to be output when the instruction input is received, and
a device controller configured to control a device which is recognized to be designated by the user, in accordance with the instruction input.

9. The information processing apparatus according to claim 1,
wherein the receiver receives the answer as audio data.

10. The information processing apparatus according to claim 1, further comprising:
a question generator configured to generate the question, and notifies the device recognition part of a correct answer to the question; and
a transmitter configured to transmit to the device a command to cause the question to be output.

11. The information processing apparatus according to claim 1, further comprising
a transmitter configured to transmit to the device a command to cause a correct answer to a question to be output by the device to be transmitted,
wherein the receiver receives a correct answer sent back from the device in accordance with the command, and notifies the device recognition part of the correct answer.

12. The information processing apparatus according to claim 1,
wherein the receiver receives the answer from a mobile device, the mobile device being placed near the user and being different from the device.

13. The information processing apparatus according to claim 1, further comprising
a transmitter configured to transmit, to a mobile device placed near the user, a command to cause a question sentence of the question to be output.

14. The information processing apparatus according to claim 13,
wherein the transmitter transmits a command to cause the question sentence to be output as an audio.

15. The information processing apparatus according to claim 1, further comprising
an output part configured to output a question sentence of the question to the user.

16. The information processing apparatus according to claim 1, further comprising
an acquisition part configured to acquire the answer,
wherein the receiver internally receives the answer from the acquisition part.

17. An information processing method comprising:
receiving an answer of a user to a question output from at least one device which has been uniquely identified on a network; and
recognizing whether the user designates the device by comparing a correct answer to the question with the answer.

18. A program for causing a computer to achieve
a function of receiving an answer of a user to a question output from at least one device which has been uniquely identified on a network, and
a function of recognizing whether the user designates the device by comparing a correct answer to the question with the answer.
